(19) United States
(12) Patent Application Publication
(10) Pub. No.: US 2012/0291984 A1
(43) Pub. Date: Nov. 22, 2012

(54) Kind Of Air Conditioner System And Control Method Of Its Condensing Fan

(75) Inventors: Jianping Li, Shenzhen (CN); Lin Wang, Xi'an (CN); Zheng Wang, Guangzhou (CN); Xianyao Yu, Shenyang (CN); Hongyu Zhang, Xi'an (CN); Zongtao Lu, Dublin, OH (US); Wanlai Lin, Dublin, OH (US); Stephen Sillato, Westerville, OH (US); John Judge, Galena, OH (US)

(73) Assignee: Liebert Corporation, Columbus, OH (US)

(21) Appl. No.: 13/295,189

(22) Filed: Nov. 14, 2011

(30) Foreign Application Priority Data
Nov. 16, 2010 (CN) 2010105456968

(51) Int. Cl. G05D 15/00; F28F 27/00

(52) U.S. Cl. 165/11.1; 165/279

(57) ABSTRACT

An air conditioner system including an indoor unit and an outdoor unit. The outdoor unit includes a condenser, a temperature sensor, a pressure sensor, and a controller. The controller detects a fault with at least one of the temperature sensor or the pressure sensor and adjusts a speed of the condensing fan according to the pressure identified by the pressure sensor when the pressure sensor is operating normally. The controller adjusts the speed of the condensing fan according to the sensed temperature sensor when the pressure experiences a fault and the temperature sensor is operating normally. The controller controls the speed of the condensing fan according to default values when both the pressure sensor and the temperature sensor experience a fault.

### CROSS-REFERENCE TO RELATED APPLICATIONS

This application claims the benefit and priority of Chinese Patent Application Serial No. 201010545696.8, filed Nov. 16, 2010, the entire disclosure of which is incorporated herein by reference.

### FIELD

The present disclosure relates to air conditioners and to control of an air conditioner condensing fan.

### BACKGROUND

This section provides background information related to the present disclosure which is not necessarily prior art.

Due to the rapid development of science and technology, and the continuous innovation and improvement of technologies, there are ever increasing requirements for reliable and highly efficient operation of air conditioner systems. The intelligent control of air conditioner systems has thus attracted more and more attention. Further, with various proposed regulations for energy saving and pollution reduction, an increased need exists for energy efficient air conditioner systems.

Air conditioner systems often include a compressor, an evaporator, a throttling device, a condenser, and a control system. In the cooling industry, it is possible to reduce energy consumption and improve energy efficiency by optimizing cooling system matching, exploiting compressor functions, improving condenser efficiency, and improving control logic. As one of the core parts of the cooling system, the fan control mode of the condenser will affect the normal and highly efficient operation of the system.

There are at least three conventional common condenser control methods or modes, each of which has particular limitations.

In a first approach, air flow of the condensing fan can be adjusted according to ambient temperature. A higher ambient temperature results in larger air flow volume of the condensing fan, and vice versa. This control mode is not as effective in windy climates, and the system may stop due to low pressure in low temperature environments.

In a second approach, the air flow of the condensing fan can be adjusted according to the temperature at the outlet of the condenser. A higher condenser outlet temperature results in larger air flow volume of the condensing fan, and vice versa. This control mode can prevent a sudden change in ambient temperature from affecting the system, but it has the following limitations: a) long response time due to the component characteristics, which makes the speed regulation of the condensing fan lag the temperature detection, system oscillation, and long stabilization time; b) it is difficult to ensure the consistent degree of subcooling under different ambient temperatures; and c) because the indoor unit cannot communicate with the outdoor unit, the outdoor unit may continue to run after the compressor stops, which will increase energy consumption and reduce efficiency.

In a third approach, the speed of the fan can be adjusted according to the outlet pressure of the condenser. A higher outlet pressure of the condenser results in a larger air flow volume of the condenser, and vice versa. This mode can ensure normal operation of the system under different ambient temperatures, and because the pressure sensor has a faster response speed, the system can be stabilized quickly. However, this control mode also has an inconsistent degree of subcooling under different ambient temperature.

Each of the above control modes is a single fault control mode. Thus, the systems will not operate normally when either the temperature sensor or the pressure sensor fails, which can decrease the efficiency of the air conditioner.

### SUMMARY

This section provides a general summary of the disclosure, and is not a comprehensive disclosure of its full scope or all of its features.

The present teachings provide for an air conditioner system including an indoor unit and an outdoor unit. The outdoor unit includes a condenser, a temperature sensor, a pressure sensor, and a controller. The temperature sensor is configured to identify a temperature. The pressure sensor is configured to identity a pressure of the condenser. The controller is configured to detect a fault in at least one of the temperature sensor or the pressure sensor. The controller adjusts a speed of the condensing fan according to the pressure identified by the pressure sensor when the pressure sensor is operating normally. The controller adjusts the speed of the condensing fan according to the temperature identified by the temperature sensor when the pressure sensor indicates a fault and the temperature sensor has not indicated a fault. The controller controls the speed of the condensing fan according to default values when both the pressure sensor and the temperature sensor have both indicated a fault.

The present teachings further provide for a method for controlling a condensing fan of an air conditioner system with a controller. The method includes determining whether a pressure sensor configured to determine sensed condensing pressure of the condenser has indicated a fault. The method further includes adjusting a speed of the condensing fan according to the sensed condensing pressure if the pressure sensor is operating normally. The method further includes determining whether a temperature sensor of the air conditioner system configured to determine a sensed temperature has indicated fault if the pressure sensor has indicated a fault. The method further includes adjusting the speed of the condensing fan according to the sensed temperature if the pressure sensor has indicated a fault. The method further includes controlling the speed of the condensing fan according to default values if both the pressure sensor and the temperature sensor have indicated a fault.

The present teachings also provide for an air conditioner system including an indoor unit and an outdoor unit. The outdoor unit includes a condenser, a condensing fan, a temperature sensor, a pressure sensor, and a controller. The temperature sensor senses a temperature. The pressure sensor senses a pressure of the condenser. The controller receives a temperature signal from the temperature sensor, a pressure signal from the pressure sensor, fault information for the temperature sensor and the pressure sensor, and controls a speed of the condensing fan based on one of the temperature and the pressure. The controller controls the speed of the condensing fan based on the pressure when the controller detects a fault in the temperature sensor. The controller controls the speed of the condensing fan based on the temperature when the controller detects a fault in the pressure sensor and does not detect fault with the temperature sensor. The controller controls the speed of the condensing fan based on default values when the controller detects fault with both the temperature sensor and the pressure sensor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a logic diagram of an air conditioner system according to the present teachings;

FIG. 2 is a flow chart of a control method for a condensing fan of the air conditioner system;

FIG. 3 is a flow chart including additional details of the control method; and

FIG. 4 is a flow chart including yet further details of the control method.

Corresponding reference numerals indicate corresponding parts throughout the several views of the drawings.

### DETAILED DESCRIPTION

Example embodiments will now be described more fully with reference to the accompanying drawings.

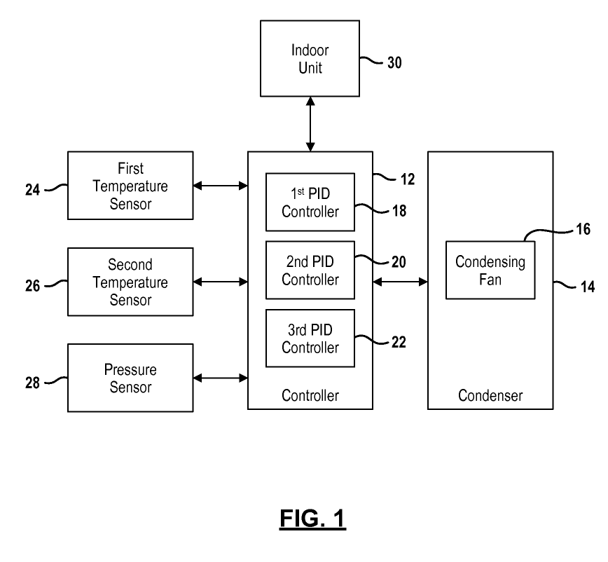

With initial reference to FIG. 1, an outdoor unit of an air conditioner system according to the present teachings generally includes a controller 12 in communication with a condenser 14 and a condensing fan 16. The controller 12 includes a first PID controller 18, a second PID controller 20, and a third PID controller 22. The controller 12 received inputs from a first temperature sensor 24, a second temperature sensor 26, and a pressure sensor 28. The controller 12 is also in communication with an indoor unit 30 of the air conditioner system.

The pressure sensor 28 can be installed at an inlet of the condenser 14 and can be used to sample the outlet pressure of the condenser 14. The first temperature sensor 24 is mounted on an outer enclosure of the condenser 14 and is used to sample ambient temperature. The second temperature sensor 26 is mounted at the outlet of the condenser 14 in various embodiments. The second temperature sensor 26 is wrapped in insulating material, such as temperature-preservation cotton, to effectively prevent heat exchange between the outlet pipe enclosure of the condenser 14 and the outside air. Second temperature sensor 26 samples the condenser outlet temperature. The controller 12 samples the condenser outlet temperature, outdoor ambient temperature, and condenser inlet or outlet pressure to control the speed of the condensing fan 16.

When the controller 12 detects that the pressure sensor 28 is operating properly and has not experienced a fault, the controller 12 adjusts the speed of condensing fan 16 according to the condensing pressure sampled by the pressure sensor 28. When the controller 12 detects that the pressure sensor 28 has experienced a fault, while the first temperature sensor 24 and the second temperature sensor 26 have not experienced faults, the controller 12 adjusts the speed of condensing fan 16 according to the ambient temperature sampled by the first temperature sensor 24 and the condenser outlet temperature sampled by the second temperature sensor 26. When the controller 12 detects that the pressure sensor 28, the first temperature sensor 24, and the second temperature sensor 26 have all experienced a fault, the controller 12 controls the speed of the condensing fan 16 according to default values. The controller 12 also reports the real time data of condenser operating status to indoor unit 30, and receives/executes start/stop commands of the indoor unit.

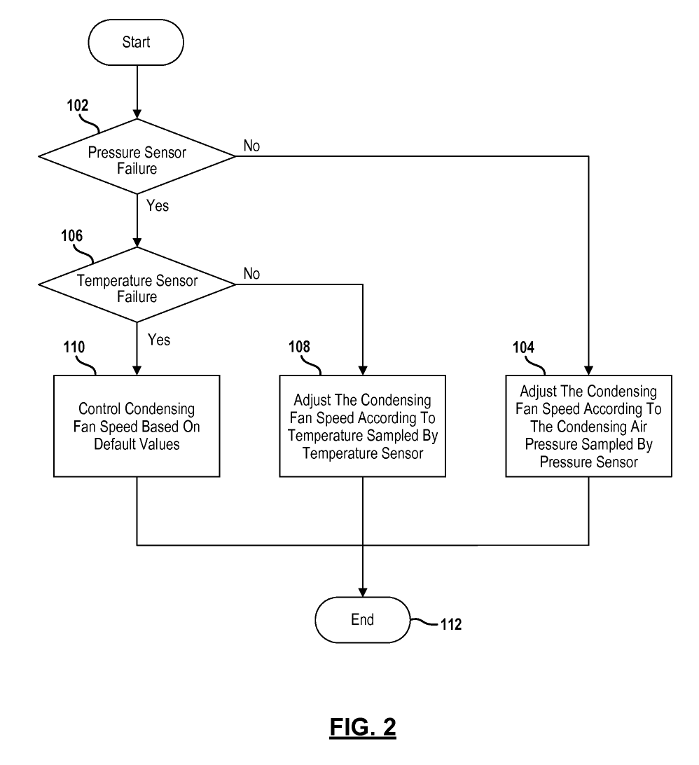

With reference to FIG. 2, control of the condenser 14 and the condensing fan 16 by the controller 12 will now be described. At block 102, the controller 12 determines whether the pressure sensor 28 failed or indicates a fault. If the pressure sensor 28 is operating properly, the controller 12 proceeds to block 104. If the pressure sensor 28 failed or indicates a fault, the controller 12 proceeds to block 106.

At block 104, the controller 12 adjusts the speed of the condensing fan 16 according to the condensing pressure sampled by the pressure sensor 28. The controller 12 then ends control.

At block 106, the controller 12 determines whether the first or the second temperature sensors 24, 26 have failed or indicates a fault. If no fault is detected and the temperature sensors 24, 26 are operating normally, control proceeds to block 108. If the controller 12 detects a fault of either the first or the second temperature sensors 24, 26, then the controller 12 proceeds to block 110.

At block 108, the controller 12 adjusts the speed of the condensing fan 16 according to the temperature sampled by at least one of the first and the second temperature sensors 24, 26. Control then proceeds to end block 112.

At block 110, the controller 12 controls the speed of the condensing fan 16 according to predetermined default values. The controller 12 then ends control. Control then proceeds to end block 112.

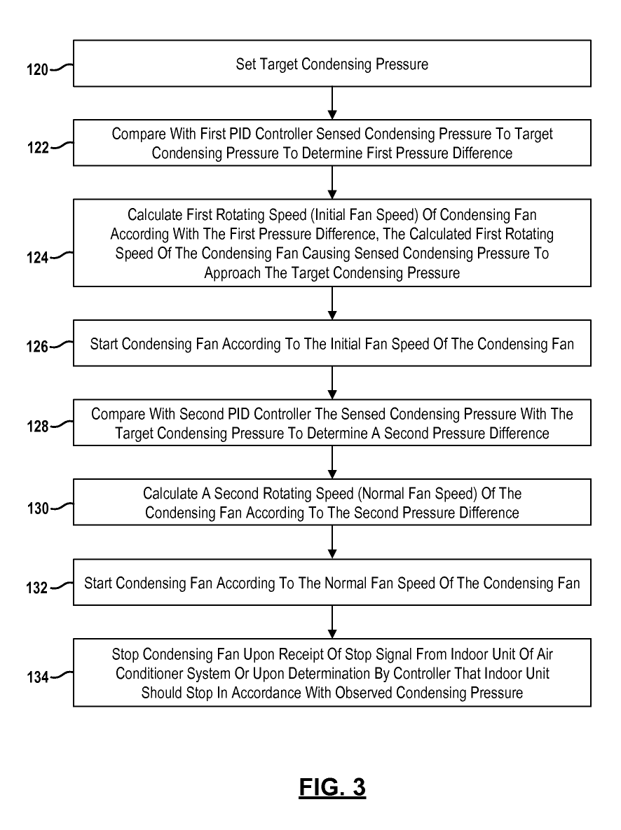

With additional reference to FIG. 3, adjustment of the condensing fan speed according to the condensing air pressure sampled by the pressure sensor 28 at block 104 will now be described further. At block 120, a target condensing pressure is set according to the kind of refrigerant used. For different kinds of refrigerants, the condensing pressure can be set within different ranges to satisfy energy saving and low noise requirements. Under normal conditions, condensing pressure can be set to a lower limit to satisfy energy saving requirements. Under other conditions, the condensing pressure can be set to a higher limit to satisfy low noise requirements. For example, if the refrigerant is R407, the low limit of the condensing pressure is about 13 bar, and the high limit of the condensing pressure is about 18 bar. By adjusting the condensing pressure, consistent condensing pressure can be maintained under different operating conditions, so the degree of subcooling can also be kept the same.

The first PID controller 18 (FIG. 1) compares the condensing pressure sampled by the pressure sensor 28 to the preset condensing pressure at block 122 of FIG. 3, and calculates a first rotating speed (initial fan speed) of the condensing fan according to the comparison result at block 124. The calculated first rotating speed of the condensing fan 16 causes the sampled condensing pressure to reach or maintain the preset condensing pressure. The controller 12 then starts the condensing fan 16 at the initial fan speed as calculated by the first PID controller 18 at block 126. When the ambient temperature is high, the sampled condensing pressure is higher than the preset condensing pressure. The user can set a higher value for the parameters of the first PID controller 18 during startup. The controller 12 causes the sampled condensing pressure to reach the preset condensing pressure in a shorter time by adjusting the rotating speed of the condensing fan 16.

The second PID controller 20 compares the condensing pressure sampled by the pressure sensor 28 to the preset condensing pressure at block 128, and calculates a second rotating speed (normal fan speed) of the condensing fan 16 according to the comparison result at block 130. The parameters of the second PID controller 20 are smaller than those of the first PID controller 18, and the normal fan speed of the condensing fan 16 causes the sampled condensing pressure to reach or maintain the preset condensing pressure. The controller 18 starts the condensing fan 16 according to the calculated second rotating speed of the condensing fan 16 at block 132.

When the sampled condensing pressure is greater than the preset condensing pressure, the speed of the condensing fan 16 is increased. If the outdoor ambient temperature is very high, the sampled condensing pressure is higher than the preset condensing pressure even if the condensing fan 16 runs at full speed, and the condensing fan 16 will run at full speed. When the sampled condensing pressure is less than the preset condensing pressure, the speed of condensing fan 16 is decreased. There is a low limit for the condensing pressure to ensure the system can run at low temperature. If the outdoor ambient temperature is very low, the sampled condensing pressure is lower than the preset condensing pressure even if the condensing fan runs at very low speed, but the sampled condensing pressure is higher than the low limit of the condensing pressure, and the condensing fan 16 will run at minimum speed. The condensing fan 16 will stop if the sampled condensing pressure is lower than the low limit of the condensing pressure.

After receiving a stop signal from the indoor unit 30, or the air conditioner system determines that the indoor unit 30 should stop according to the sampled condensing pressure, the controller 12 stops operation of the condensing fan 16 at block 134 of FIG. 3.

If the indoor unit 30 communicates with the outdoor unit including the controller 12, a controller of the indoor unit 30 will control a compressor in the indoor unit 30 to stop and then send out the stop signal to the outdoor unit. After the controller 12 receives the stop signal, the outdoor unit will run at the current speed for some time and then stop. If there is no communication between the indoor unit 30 and the controller 12 of the outdoor unit, the outdoor unit does not determine whether the compressor inside the indoor unit 30 has stopped, so the system will determine if the compressor has stopped by using the sampled condensing pressure. For example, if the sampled condensing pressure change exceeds a preset pressure change, or if the condensing pressure change rate exceeds a preset pressure change rate, the condensing fan 16 will stop.

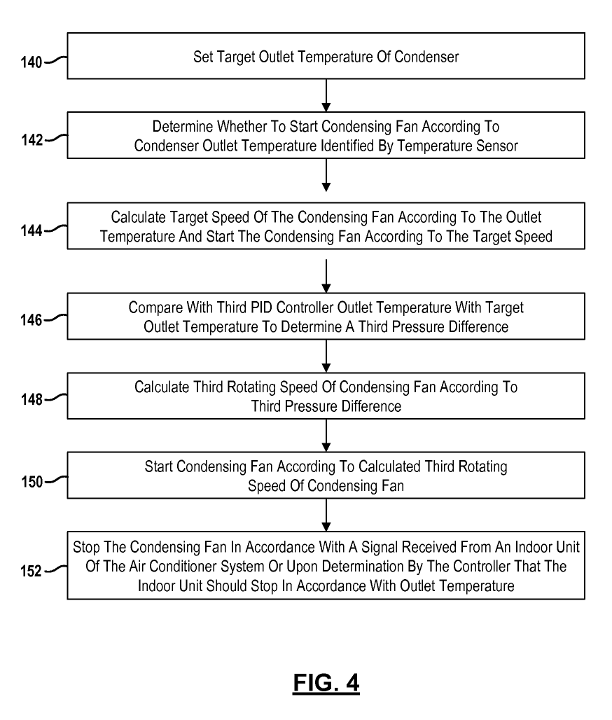

Adjustment of the condensing fan speed according to the temperature sampled by the temperature sensors 24 and 26 at block 108 will now be described further and with additional reference to FIG. 4. A target condenser outlet temperature is set at block 140 within a range so as to ensure the system can operate under different operating conditions and meet different requirements for energy saving and low noise. Under normal conditions, the condenser outlet temperature is set to a low limit. For example, a low limit of the condenser outlet temperature may be 20° C. Under special conditions, to meet low noise requirements, the condenser outlet temperature is set to a higher limit. For example, the higher limit of the condenser outlet temperature may be 36° C. By setting the condenser outlet temperature, consistent condenser outlet temperature can be maintained under different operating conditions, so the degree of subcooling can also be kept the same.

The controller 12 determines whether to start the condensing fan 16 according to the condenser outlet temperature identified by the second temperature sensor 26 at block 142. If it is necessary to start the condensing fan 16, the speed of the condensing fan 16 is calculated according to the ambient temperature sampled by the first temperature sensor 24, and the condensing fan 16 is started according to the calculated fan speed at block 144. In order to eliminate the influence of lag of the control system based on condenser outlet temperature, control based on ambient temperature is introduced in the control based on the condenser outlet temperature. That is, it is first determined whether to start the condensing fan 16 according to the condenser outlet temperature. If it is determined to start the condensing fan 16, the speed of the condensing fan 16 is calculated according to the ambient temperature, and then the condensing fan 16 is started according to the calculated fan speed. The start speed of the condensing fan 16 is dependent on the ambient temperature. For different ambient temperatures, the start speed is different, which ensures consistent response of the first temperature sensor 24 to the condensing fan speed regulation and ensures that the system is stabilized quickly.

The third PID controller 22 compares the condenser outlet temperature identified by the second temperature sensor 26 to the target or preset condenser outlet temperature at block 146, and calculates a third rotating speed of the condensing fan 16 according to the comparison result at block 148. The calculated third rotating speed of the condensing fan 16 causes the identified condenser outlet temperature to reach or remain at the preset condenser outlet temperature. The condensing fan 16 is then started according to the calculated third rotating speed of the condensing fan 16 at block 150. When the identified condenser outlet temperature is higher than the preset condenser outlet temperature, the speed of the condensing fan 16 is increased. If the outdoor ambient temperature is very high, the sampled condenser outlet temperature is higher than the preset condenser outlet temperature even if the condensing fan runs at full speed, and the condensing fan will run at full speed. When the condenser outlet temperature is lower than the preset condenser outlet temperature, the speed of condensing fan 16 is lowered. There is a low limit for the condenser outlet temperature to ensure the system can run at low temperature. Considering the degree of subcooling, there is also a low limit for the condenser outlet temperature. If the outdoor ambient temperature is very low, the sampled condenser outlet temperature is lower than the preset condenser outlet temperature even if the condensing fan runs at very low speed, but the sampled condenser outlet temperature is higher than the low limit of the condenser outlet temperature, and the condensing fan will run at minimum speed all along. At this time, the condensing fan 16 will stop if the sampled condenser outlet temperature is lower than the low limit of the condenser outlet temperature.

After receiving the stop signal from indoor unit 30, or the air conditioner system determines that the indoor unit 30 should stop according to the condenser outlet temperature sampled by the second temperature sensor 26, the controller 12 will stop operation of the condensing fan 16.

If the indoor unit 30 communicates with the outdoor unit including the controller 12, a control board of the indoor unit 30 will control the compressor of the indoor unit to stop and then send out the stop signal to the controller 12 of the outdoor unit. At block 152, after the controller 12 of the outdoor unit receives the stop signal, the outdoor unit will run at the current speed for some time and then stop. If there is no communication between the indoor unit and the outdoor unit, the outdoor unit cannot determine whether the compressor inside the indoor unit has stopped. The system will then determine if the compressor has stopped based on the sampled condenser outlet temperature. For example, if the sampled condenser outlet temperature change exceeds a preset temperature change, or if the condenser outlet temperature change rate exceeds a preset change rate, the condensing fan 16 will stop.

The present teachings thus provide for an air conditioner system including an indoor unit 30 and an outdoor unit. The outdoor unit includes the condenser 14, the condensing fan 16, temperature sensors 24/26 used for sampling temperature, the pressure sensor 28 used for sampling condensing pressure, and the controller 12. The controller 12 detects if the pressure sensor 28 and/or either of the temperature sensors 24, 26 have failed or generated a fault, adjusts the speed of condensing fan 16 according to the condensing pressure sampled by the pressure sensor 28 when the pressure sensor 28 has no fault. Controller 12 also adjusts the speed of condensing fan 16 according to the temperature sampled by the temperature sensors 24 and/or 26 when the pressure sensor 28 has failed or generated a fault, but the temperature sensors 24, 26 have not failed or generated a fault. Controller 12 also controls the speed of the condensing fan 16 according to default values when both the pressure sensor 28 and one or more of the temperature sensors 24, 26 have fault. Thus, control can automatically switch from a single control method when the single control method fails to ensure normal and high efficiency operation of the air conditioner.

In various embodiments, the present teachings resolve the issue of low air conditioner efficiency caused by single control mode of a condensing fan. In various other embodiments, the control mode of the present teachings can ensure the normal and high efficiency operation of the air conditioner because the system can transfer to another control mode when one control mode fails.

The pressure control mode is selected when the pressure sensor 28 has not failed or indicated a fault to ensure that the air conditioner system operates normally under different ambient temperatures and to avoid system oscillation due to ambient temperature change. In addition, because the pressure sensor 28 has a faster response speed, the system can be stabilized quickly. When the pressure sensor 28 fails and the temperature sensors 24, 26 are normal, the system is switched to temperature control mode automatically. When both the pressure sensor 28 and temperature sensors 24, 26 have fault, the system controls the speed of the condensing fan 16 according to the default values. Therefore, the system can transfer to another control mode when one control mode fails to ensure the normal and high efficiency operation of the system.

Moreover, since the target or preset condensing pressure and the target or preset condenser outlet temperature are adjustable, the condensing pressure or the condenser outlet temperature is basically same under different outdoor ambient temperatures, which makes the degree of subcooling basically consistent. The air conditioner system uses a condensing fan 16 with an adjustable speed in order to adapt to outdoor conditions flexibly, which permits operation under lower outdoor temperatures.

The condensing fan speed is thus adjustable as described herein. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An air conditioner system including an indoor unit and an outdoor unit, the outdoor unit comprising:
a condenser;
a condensing fan;
a temperature sensor configured to identify a temperature;
a pressure sensor configured to identity a pressure of the condenser;
a controller configured to:
detect a fault in at least one of the temperature sensor or the pressure sensor;
adjust a speed of the condensing fan according to the pressure identified by the pressure sensor when the pressure sensor is operating normally;
adjust the speed of the condensing fan according to the temperature identified by the temperature sensor when the pressure sensor indicates a fault and the temperature sensor has not indicated a fault; and
control the speed of the condensing fan according to default values when both the pressure sensor and the temperature sensor have both indicated a fault.

2. The air conditioner system of claim 1, the temperature sensor comprising:
a first temperature sensor configured to identify an ambient temperature; and
a second temperature sensor configured to identify an outlet temperature of the condenser.

3. The air conditioner system of claim 1, wherein the pressure sensor is configured to identify at least one of an outlet pressure or an inlet pressure of the condenser.

4. The air conditioner system of claim 1, wherein the speed of the condensing fan is adjustable.

5. A method for controlling a condensing fan of an air conditioner system with a controller comprising:
determining whether a pressure sensor configured to determine sensed condensing pressure of the condenser has indicated a fault;
adjusting a speed of the condensing fan according to the sensed condensing pressure if the pressure sensor is operating normally;
determining whether a temperature sensor of the air conditioner system configured to determine a sensed temperature has indicated fault if the pressure sensor has indicated a fault;
adjusting the speed of the condensing fan according to the sensed temperature if the pressure sensor has indicated a fault; and
controlling the speed of the condensing fan according to default values if both the pressure sensor and the temperature sensor have indicated a fault.

6. The method of claim 5, further comprising adjusting the speed of the condensing fan according to the sensed condensing pressure identified by the pressure sensor by:
setting a target condensing pressure;
comparing with a first PID controller the sensed condensing pressure to the target condensing pressure to determine a first pressure difference;
calculating a first rotating speed of the condensing fan according with the first pressure difference, the calculated first rotating speed of the condensing fan causing the sensed condensing pressure to approach the target condensing pressure;
starting the condensing fan according to the calculated first rotating speed of the condensing fan;
comparing with a second PID controller the sensed condensing pressure with the target condensing pressure to determine a second pressure difference;
calculating a second rotating speed of the condensing fan according to the second pressure difference, wherein parameters of the second PID controller are less than parameters of the first PID controller and the calculated second rotating speed causes the sensed condensing pressure to approach the target condensing pressure;
starting the condensing fan according to the calculated second rotating speed of the condensing fan; and
stopping the condensing fan upon receipt of a stop signal from an indoor unit of the air conditioner system or upon determination by the controller that the indoor unit should stop in accordance with the observed condensing pressure.

7. The method of claim 6, wherein the condensing pressure is the outlet pressure or the inlet pressure of the condenser.

8. The method of claim 5, further comprising adjusting the speed of the condensing fan according to the sensed temperature sensor by:
setting a target outlet temperature of the condenser;
determining whether to start the condensing fan based on outlet temperature;
calculating a target speed of the condensing fan according to the outlet temperature and starting the condensing fan according to the target speed when the controller determines to start the condensing fan;
comparing with a third PID controller the outlet temperature with the target outlet temperature to determine a third pressure difference;
calculating a third rotating speed of the condensing fan according to the third pressure difference, the calculated third rotating speed causing the outlet temperature to approach the target outlet temperature;
starting the condensing fan according to the calculated third rotating speed of the condensing fan; and
stopping the condensing fan in accordance with a signal received from an indoor unit of the air conditioner system or upon determination by the controller that the indoor unit should stop in accordance with the outlet temperature.

9. An air conditioner system including an indoor unit and an outdoor unit, the outdoor unit comprising:
a condenser;
a condensing fan;
a temperature sensor sensing a temperature;
a pressure sensor sensing a pressure of the condenser;
a controller receiving a temperature signal from the temperature sensor, a pressure signal from the pressure sensor, fault information for the temperature sensor and the pressure sensor, and controlling a speed of the condensing fan based on one of the temperature and the pressure;
wherein the controller controls the speed of the condensing fan based on the pressure when the controller detects a fault in the temperature sensor;
wherein the controller controls the speed of the condensing fan based on the temperature when the controller detects a fault with the pressure sensor and does not detect a fault with the temperature sensor; and
wherein the controller controls the speed of the condensing fan based on default values when the controller detects fault with both the temperature sensor and the pressure sensor.

10. The air conditioner system of claim 9, wherein the temperature further comprises:
a first temperature sensor senses an ambient temperature; and
a second temperature sensor senses an outlet temperature of the condenser.

11. The air conditioner system of claim 10, wherein the pressure sensor identifies at least one of an outlet pressure or an inlet pressure of the condenser.

12. The air conditioner system of claim 9, wherein the controller includes a first PID controller, a second PID controller, and a third PID controller,
wherein the first PID controller calculates a first rotating speed of the condensing fan based on a first difference between observed pressure of the condenser and a target pressure of the condenser;
wherein the second PID controller calculates a second rotating speed of the condensing fan based on a second difference between the sensed pressure of the condenser and a target pressure of the condenser; and
wherein the third PID controller calculates a third rotating speed of the condensing fan based on a third difference between sensed temperature of the condenser and a target temperature of the condenser.

13. The air conditioner system of claim 9, wherein the controller receives a stop signal for the condensing fan from the indoor unit.
